(19) United States
(12) Patent Application Publication
(10) Pub. No.: US 2025/0189795 A1
(43) Pub. Date: Jun. 12, 2025

(54) MIXED REALITY DISPLAY DEVICE

(71) Applicant: National Central University, Taoyuan City (TW)

(72) Inventors: Yeh-Wei YU, Taoyuan City (TW); Ching-Cherng SUN, Taoyuan City (TW); Chih-Yuan CHENG, Tainan City (TW); Chih-Hung CHEN, Hsinchu County (TW); Tsung-Hsun YANG, Taoyuan City (TW); Shiuan-Huei LIN, Hsinchu City (TW); Cheng-Chuan LIU, Taoyuan City (TW)

(21) Appl. No.: 18/667,485

(22) Filed: May 17, 2024

(30) Foreign Application Priority Data
Dec. 12, 2023 (TW) 112148373

(51) Int. Cl. G02B 27/01

(52) U.S. Cl. CPC G02B 27/0172; G02B 2027/0123; G02B 2027/0174

(57) ABSTRACT

A mixed reality display device includes a waveguide element, an image light source, a first diffractive optical element lens array and a second diffractive optical element lens array. The image light source is located in the waveguide element. The first diffractive optical element lens array is located on a first side of the waveguide element facing a human eye, the first diffractive optical element lens array includes a plurality of diffractive optical element lenses, and any of the diffractive optical element lenses is configured to converge a light. The second diffractive optical element lens array is located on a second side of the waveguide element opposite to the first side, the second diffractive optical element lens array includes a plurality of diffractive optical element lenses, and any of the diffractive optical element lenses is configured to diverge or converge a light.

### RELATED APPLICATIONS

This application claims priority to Taiwan Application Serial Number 112148373, filed Dec. 12, 2023, which is herein incorporated by reference.

### BACKGROUND

### Field of Disclosure

The present disclosure relates to a mixed reality display device.

### Description of Related Art

Near-eye displays have become the mainstream of mobile display in recent years. Near-eye display can be integrated into portable devices, such as glasses and head-mounted displays, to increase convenience of display. In the field of mixed reality (MR) display, exit pupil expansion (EPE) technology is crucial to a viewer's experience. The area of the image incident area is usually much smaller than that of the image exit area, since it is limited by the size of the near-eye display. How to extend the image to the extent that it can be clearly viewed by a human eye from different directions is an important subject for mixed reality near-eye display designers.

### SUMMARY

One aspect of the present disclosure provides a mixed reality display device.

According to one embodiment of the present disclosure, a mixed reality display device includes a waveguide element, an image light source, a first diffractive optical element lens array, and a second diffractive optical element lens array. The image light source is located in the waveguide element, and is configured for total internal reflection to on an image to be transferred. The first diffractive optical element lens array is located on a first side of the waveguide element facing a human eye. The first diffractive optical element lens array includes a plurality of diffractive optical element lenses. The diffractive optical element lenses are arranged in an array, and any of the diffractive optical element lenses is configured to converge a light. The second diffractive optical element lens array is located on a second side of the waveguide element opposite to the first side. The second diffractive optical element lens array includes a plurality of diffractive optical element lenses. The diffractive optical element lenses are arranged in an array, and any of the diffractive optical element lenses is configured to diverge or converge a light.

In some embodiment of the present disclosure, the diffractive optical element lenses in the first diffractive optical element lens array are composed from a volume holographic optical element formed in a recording of recording the interference between a plane wave and a spherical wave by repeating the above step at different positions in a same holographic photosensitive film, such that the diffractive optical element lenses are composed in a form of an array.

In some embodiment of the present disclosure, the diffractive optical element lenses in the first diffractive optical element lens array are composed from a volume holographic optical element formed in a recording of the interference between a plane wave array and a spherical wave array, such that the diffractive optical element lenses are composed in a form of an array.

In some embodiment of the present disclosure, the diffractive optical element lenses in the second diffractive optical element lens array are composed from a volume holographic optical element formed in a recording of the interference between a plane wave and a spherical wave by repeating the above step at different positions in a same holographic photosensitive film, such that the diffractive optical element lenses are composed in a form of an array.

In some embodiment of the present disclosure, the diffractive optical element lenses in the second diffractive optical element lens array are composed from a volume holographic optical element formed in a recording of the interference between a plane wave array and a spherical wave array, such that the diffractive optical element lenses are composed in a form of an array.

In some embodiment of the present disclosure, the diffractive optical element lenses in the second diffractive optical element lens array are composed from a volume holographic optical element formed in a recording of the interference between a spherical wave and a spherical wave by repeating the above step at different positions in a same holographic photosensitive film, such that the diffractive optical element lenses are composed in a form of an array.

In some embodiment of the present disclosure, the diffractive optical element lenses in the second diffractive optical element lens array are composed from a volume holographic optical element formed in a recording of the interference between a spherical wave array and a spherical wave array, such that the diffractive optical element lenses are composed in a form of an array.

In some embodiment of the present disclosure, one of the diffractive optical element lenses in the first diffractive optical element lens array and one in the corresponding position of the diffractive optical element lenses in the second diffractive optical element lens array together compose a afocal system.

In some embodiment of the present disclosure, the afocal system is a beam condensing system.

In some embodiment of the present disclosure, the angular magnification M of the afocal system is expressed by the following formula:

$$M = \frac{{f}_{1}}{{f}_{1} - t}$$

wherein, f₁ is the focal length of the first diffractive optical element lens array, t is an effective distance between the first diffractive optical element lens array and the second diffractive optical element lens array, and the value of the effective distance is equal to the geometrical distance between the first diffractive optical element lens array and the second diffractive optical element lens array divided by a medium refractive index.

In some embodiment of the present disclosure, there is an air layer between the second diffractive optical element lens array and the waveguide element.

In some embodiment of the present disclosure, the mixed reality display device further includes a light shield element. The light shield element is located between the second diffractive optical element lens array and the waveguide element, and is configured to eliminate the phenomenon of crosstalk between the diffractive optical element lenses.

In some embodiment of the present disclosure, the light shield element is produced by scoring a surface of a transparent element and filling with a light absorbing material.

In some embodiment of the present disclosure, the first diffractive optical element lens array is a holographic optical element.

In some embodiment of the present disclosure, the second diffractive optical element lens array is a holographic optical element.

In the above embodiments of the present disclosure, since in the mixed reality display device, the first diffractive optical element lens array and the second diffractive optical element lens array, which can be equivalent to lenses, are used to magnify the field of view, the purpose of exit pupil dilation is achieved, and the viewing experience of the mixed reality display device is improved, so that the human eye from different angles can see the image.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a cross-sectional view of a mixed reality display device according to an embodiment of the present disclosure.

FIG. 2 illustrates a top view of a first diffractive optical element lens array in FIG. 1.

FIG. 3 illustrates a top view of a second diffractive optical element lens array in FIG. 1.

FIG. 4 illustrates a cross-sectional view of a mixed reality display device according to another embodiment of the present disclosure.

FIG. 5 illustrates a cross-sectional view of a mixed reality display device according to yet another embodiment of the present disclosure.

FIG. 6 illustrates a cross-sectional view of a mixed reality display device according to still another embodiment of the present disclosure.

FIG. 7 illustrates a cross-sectional view of a mixed reality display device according to still yet another embodiment of the present disclosure.

FIG. 8 illustrates a cross-sectional view of a pair of mixed reality glasses according to an embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

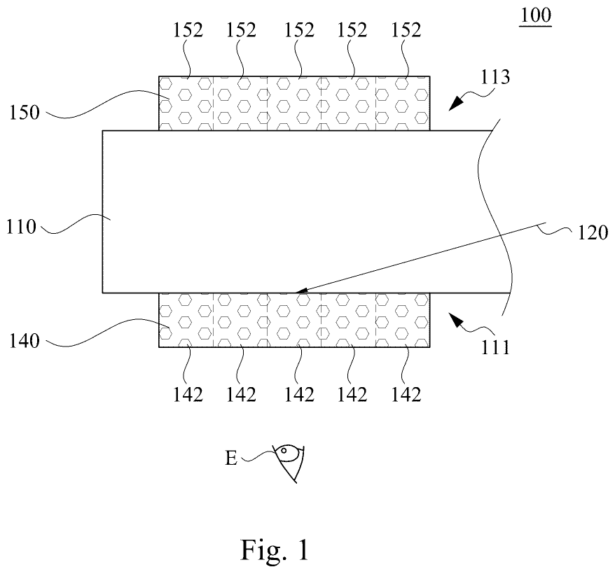

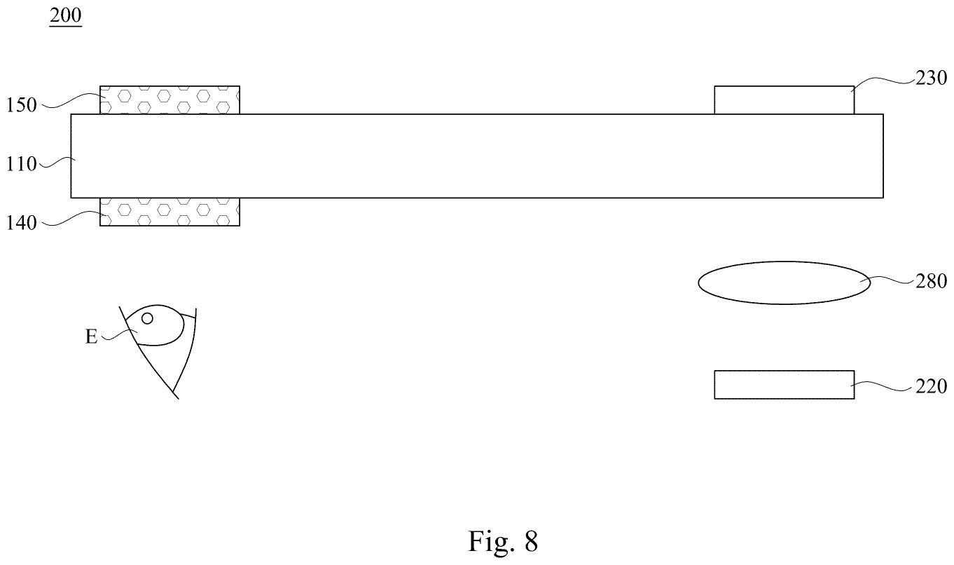

FIG. 1 illustrates a cross-sectional view of a mixed reality display device 100 according to an embodiment of the present disclosure. Referring to FIG. 1, the mixed reality display device 100 includes a waveguide element 110, an image light source 120, a first diffractive optical element lens array 140, and a second diffractive optical element lens array 150. The image light source 120 is located in the waveguide element 110, and is configured for total internal reflection on an image to be transferred. In practical applications, the image light source 120 may refer to an image generating device in FIG. 8. The first diffractive optical element lens array 140 is located on a first side 111 of the waveguide element 110 facing a human eye E, and the second diffractive optical element lens array 150 is located on a second side 113 of the waveguide element 110 opposite to the first side 111.

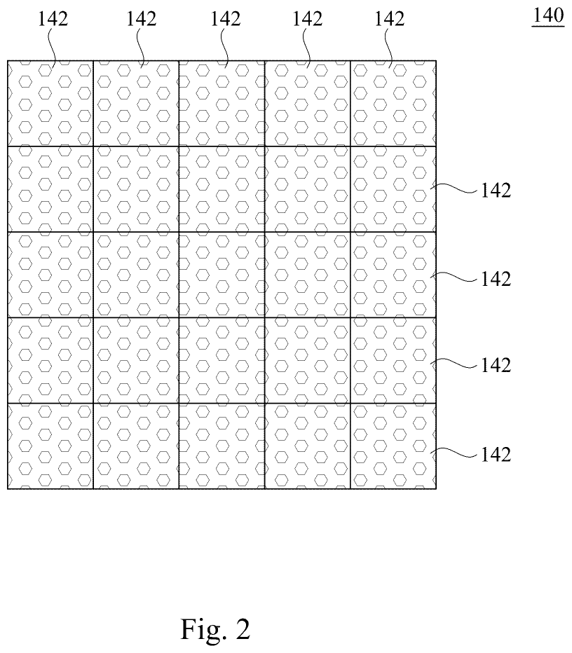

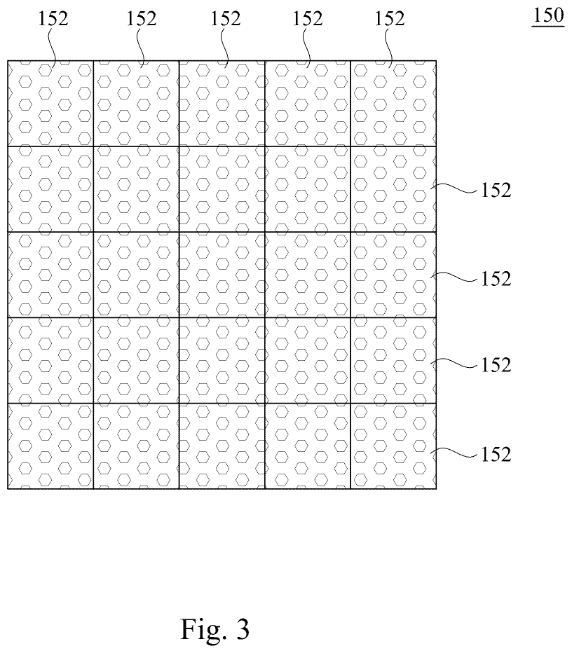

FIG. 2 illustrates a top view of the first diffractive optical element lens array 140 in FIG. 1. FIG. 3 illustrates a top view of the second diffractive optical element lens array 150 in FIG. 1. Referring to FIGS. 2 and 3, the first diffractive optical element lens array 140 includes a plurality of diffractive optical element lenses 142. The diffractive optical element lenses 142 are arranged in an array, and any of the diffractive optical element lenses 142 is configured to converge a light. The second diffractive optical element lens array 150 includes a plurality of diffractive optical element lenses 152. The diffractive optical element lenses 152 are arranged in an array, and any of the diffractive optical element lenses 152 is configured to diverge or converge a light. That is to say, the diffractive optical element lenses 152 may be equivalent to a converging lens or a diverging lens, and the diffractive optical element lenses 142 may be equivalent to a converging lens. In FIGS. 2 and 3, twenty five diffractive optical element lenses are shown for the diffractive optical element lenses 142 and the diffractive optical element lenses 152, respectively. However, the present disclosure is not limited thereto. For example, the second diffractive optical element lens array 150 may include more diffractive optical element lenses 152, as long as each of the diffractive optical element lenses 142 corresponds to one of the diffractive optical element lenses 152 on a one-to-one basis in position.

Referring to FIG. 1, one of the diffractive optical element lenses 142 in the first diffractive optical element lens array 140 (for example, the leftmost diffractive optical element lens 142 in FIG. 1) and one in the corresponding position of the diffractive optical element lenses 152 in the second diffractive optical element lens array 150 (for example, the leftmost diffractive optical element lens 152 in FIG. 1) together compose an afocal system. It should be clarified first that the so-called “afocal system” here and below means that focal points of a group of lenses coincide with each other. Each of the afocal systems is a beam condensing system, and the angular magnification M of the afocal system is expressed by the following calculation formula:

$$M = \frac{{f}_{1}}{{f}_{1} - t}$$

f₁ is the focal length of the first diffractive optical element lens array 140, t is an effective distance between the first diffractive optical element lens array 140 and the second diffractive optical element lens array 150, and the value of the effective distance is equal to the distance between the first diffractive optical element lens array 140 and the second diffractive optical element lens array 150 divided by the medium refractive index of the waveguide element 110.

Since in the mixed reality display device 100, the first diffractive optical element lens array 140 and the second diffractive optical element lens array 150, which can be equivalent to lenses, are used to magnify the field of view, the purpose of exit pupil dilation is achieved, and the viewing experience of the mixed reality display device 100 is improved, so that the human eye E from different angles can see the image.

In some embodiments, the diffractive optical element lenses 142 in the first diffractive optical element lens array 140 are composed from a volume holographic optical element (VHOE) formed in a recording of the interference between a plane wave and a spherical wave by repeating the above step at different positions in a same holographic photosensitive film, such that the diffractive optical element lenses 142 are composed in a form of an array. In other embodiments, the diffractive optical element lenses 142 in the first diffractive optical element lens array 140 may be composed from a volume holographic optical element formed in a recording of the interference between a plane wave array and a spherical wave array, such that the diffractive optical element lenses 142 are composed in a form of an array. In some embodiments, the first diffractive optical element lens array 140 is a holographic optical element.

In some embodiments, the diffractive optical element lenses 152 in the second diffractive optical element lens array 150 are composed from a volume holographic optical element formed in a recording of the interference between a plane wave and a spherical wave by repeating the above step at different positions in a same holographic photosensitive film, such that the diffractive optical element lenses 152 are composed in a form of an array. In some embodiments, the diffractive optical element lenses 152 in the second diffractive optical element lens array 150 are composed from a volume holographic optical element formed in a recording of the interference between a plane wave array and a spherical wave array, such that the diffractive optical element lenses 152 are composed in a form of an array. In some embodiments, the diffractive optical element lenses 152 in the second diffractive optical element lens array 150 are composed from a volume holographic optical element formed in a recording of the interference between a spherical wave and a spherical wave by repeating the above step at different positions in a same holographic photosensitive film, such that the diffractive optical element lenses 152 are composed in a form of an array. In other embodiments, the diffractive optical element lenses 152 in the second diffractive optical element lens array 150 may be composed from a volume holographic optical element formed in a recording of the interference between a spherical wave array and a spherical wave array, such that the diffractive optical element lenses 152 are composed in a form of an array. In some embodiments, the second diffractive optical element lens array 150 is a holographic optical element.

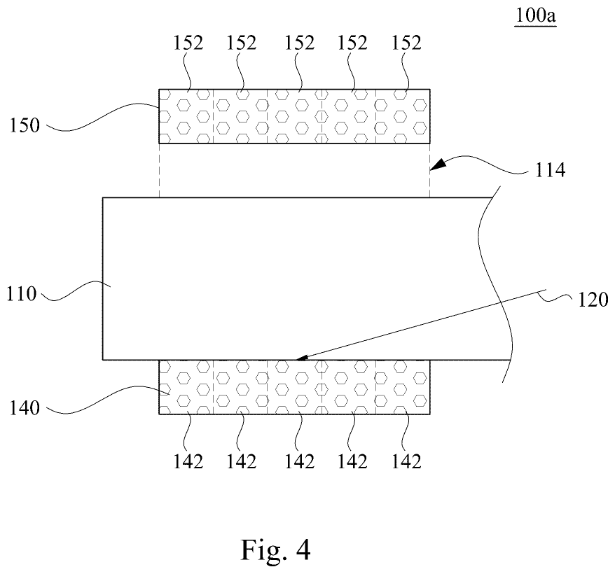

FIG. 4 illustrates a cross-sectional view of a mixed reality display device 100a according to another embodiment of the present disclosure. Referring to FIG. 4, the mixed reality display device 100a includes a waveguide element 110, an image light source 120, a first diffractive optical element lens array 140, and a second diffractive optical element lens array 150. The present embodiment is different from the embodiment in FIG. 1 in that, in the present embodiment, there is an air layer 114 between the second diffractive optical element lens array 150 and the waveguide element 110. The air layer 114 may be such that one of the diffractive optical element lenses 142 in the first diffractive optical element lens array 140 (for example, the leftmost diffractive optical element lens 142 in FIG. 4) and one in the corresponding position of the diffractive optical element lenses 152 in the second diffractive optical element lens array 150 (for example, the leftmost diffractive optical element lens 152 in FIG. 4) can compose one afocal system, thereby achieving the same effect as the embodiment in FIG. 1.

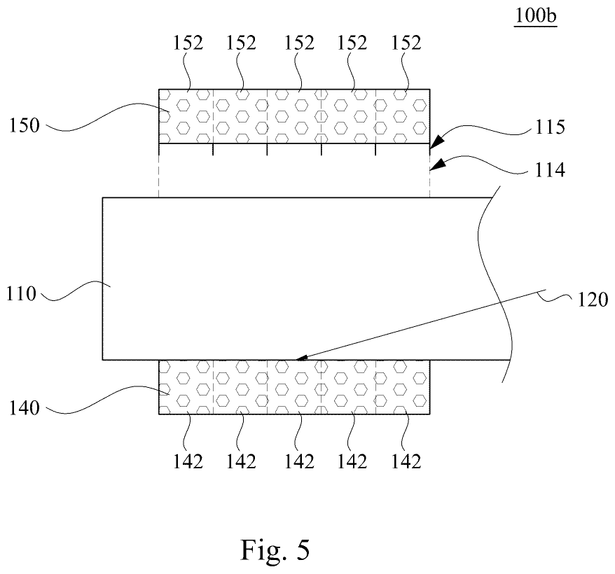

FIG. 5 illustrates a cross-sectional view of a mixed reality display device 100b according to yet another embodiment of the present disclosure. Referring to FIG. 5, the mixed reality display device 100b includes a waveguide element 110, an image light source 120, a first diffractive optical element lens array 140, and a second diffractive optical element lens array 150. The present embodiment is different from the embodiment in FIG. 4 in that, in the present embodiment, the mixed reality display device 100b further includes a light shield element 115. The light shield element 115 is located between the second diffractive optical element lens array 150 and the waveguide element 110, and is configured to eliminate the phenomenon of crosstalk between the diffractive optical element lenses 152.

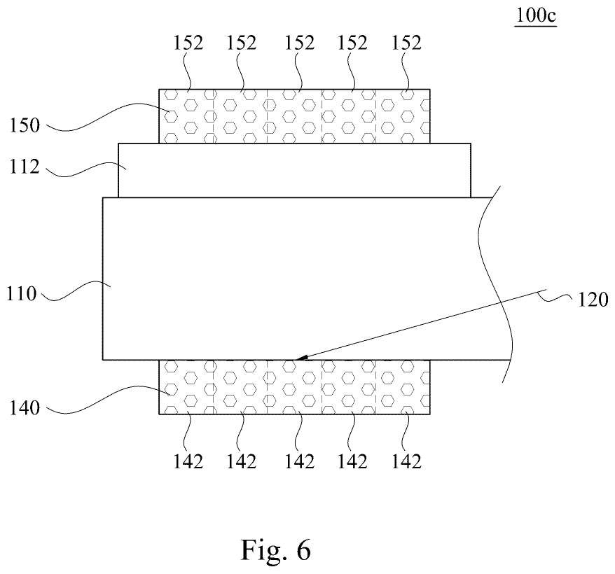

FIG. 6 illustrates a cross-sectional view of a mixed reality display device 100c according to yet still another embodiment of the present disclosure. Referring to FIG. 6, the mixed reality display device 100c includes a waveguide element 110, an image light source 120, a first diffractive optical element lens array 140, and a second diffractive optical element lens array 150. The present embodiment is different from the embodiment in FIG. 1 in that, in the present embodiment, the mixed reality display device 100c further includes a transparent element 112. The material of the transparent element 112 may include glass or acrylic, but is not limited to the above. The transparent element 112 may be such that one of the diffractive optical element lenses 142 in the first diffractive optical element lens array 140 (for example, the leftmost diffractive optical element lens 142 in FIG. 6) and one in the corresponding position of the diffractive optical element lenses 152 in the second diffractive optical element lens array 150 (for example, the leftmost diffractive optical element lens 152 in FIG. 6) can compose one afocal system, thereby achieving the same effect as the embodiment in FIG. 1.

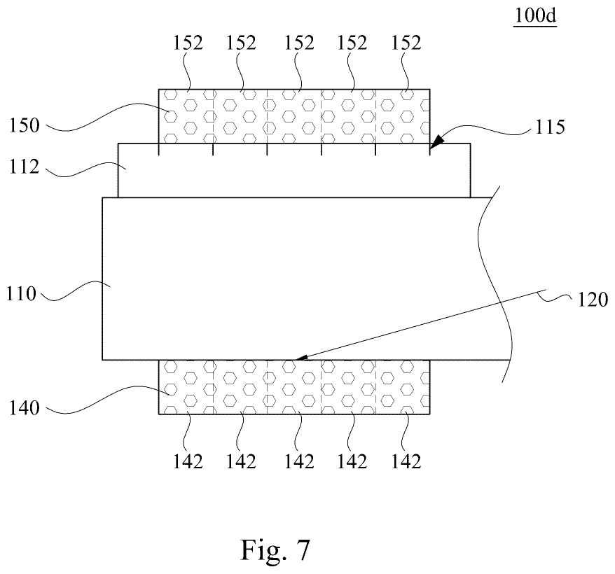

FIG. 7 illustrates a cross-sectional view of a mixed reality display device 100d according to still yet another embodiment of the present disclosure. Referring to FIG. 7, the mixed reality display device 100d includes a waveguide element 110, an image light source 120, a first diffractive optical element lens array 140, and a second diffractive optical element lens array 150. The present embodiment is different from the embodiment in FIG. 6 in that, in the present embodiment, the mixed reality display device 100d further includes a light shield element 115, and the light shield element 115 is produced by scoring a surface of the transparent element 112 and filling with a light absorbing material. Furthermore, the light shield element 115 is configured to eliminate the phenomenon of crosstalk between the diffractive optical element lenses 152.

FIG. 8 illustrates a cross-sectional view of a pair of mixed reality glasses 200 according to an embodiment of the present disclosure. Referring to FIG. 8, the pair of mixed reality glasses 200 includes a mixed reality display device 100, a third holographic optical element 230, a projection device 280, and an image generating device 220. The mixed reality display device 100 in FIG. 8 can be replaced with the above-mentioned mixed reality display device 100a, 100b, 100c, or 100d. The image generating device 220 is configured to generate an image that is equivalent to the image light source 120 in FIG. 1. The projection device 280 is configured such that the image is imaged at infinity. The third holographic optical element 230 is configured to guide the image into the waveguide element 110.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A mixed reality display device, comprising:
a waveguide element;
an image light source located in the waveguide element, and for total internal reflection on an image to be transferred;
a first diffractive optical element lens array located on a first side of the waveguide element facing a human eye, the first diffractive optical element lens array comprising a plurality of diffractive optical element lenses, the diffractive optical element lenses being arranged in an array, and any of the diffractive optical element lenses being configured to converge a light; and
a second diffractive optical element lens array located on a second side of the waveguide element opposite to the first side, the second diffractive optical element lens array comprising a plurality of diffractive optical element lenses, the diffractive optical element lenses being arranged in an array, and any of the diffractive optical element lenses being configured to diverge or converge a light.

2. The mixed reality display device according to claim 1, wherein the diffractive optical element lenses in the first diffractive optical element lens array are composed from a volume holographic optical element formed in a recording of an interference between a plane wave and a spherical wave by repeating the above step at different positions in a same holographic photosensitive film, such that the diffractive optical element lenses are composed in a form of an array.

3. The mixed reality display device according to claim 1, wherein the diffractive optical element lenses in the first diffractive optical element lens array are composed from a volume holographic optical element formed in a recording of an interference between a plane wave and a spherical wave array, such that the diffractive optical element lenses are composed in a form of an array.

4. The mixed reality display device according to claim 1, wherein the diffractive optical element lenses in the second diffractive optical element lens array are composed from a volume holographic optical element formed in a recording of an interference between a plane wave and a spherical wave by repeating the above step at different positions in a same holographic photosensitive film, such that the diffractive optical element lenses are composed in a form of an array.

5. The mixed reality display device according to claim 1, wherein the diffractive optical element lenses in the second diffractive optical element lens array are composed from a volume holographic optical element formed in a recording of an interference between a plane wave and a spherical wave array, such that the diffractive optical element lenses are composed in a form of an array.

6. The mixed reality display device according to claim 1, wherein the diffractive optical element lenses in the second diffractive optical element lens array are composed from a volume holographic optical element formed in a recording of an interference between a spherical wave and a spherical wave by repeating the above step at different positions in a same holographic photosensitive film, such that the diffractive optical element lenses are composed in a form of an array.

7. The mixed reality display device according to claim 1, wherein the diffractive optical element lenses in the second diffractive optical element lens array are composed from a volume holographic optical element formed in a recording of an interference between a spherical wave array and a spherical wave array, such that the diffractive optical element lenses are composed in a form of an array.

8. The mixed reality display device according to claim 1, wherein one of the diffractive optical element lenses in the first diffractive optical element lens array and one in the corresponding position of the diffractive optical element lenses in the second diffractive optical element lens array together compose a afocal system.

9. The mixed reality display device according to claim 8, wherein the afocal system is a beam condensing system.

10. The mixed reality display device according to claim 8, wherein an angular magnification M of the afocal system is expressed by the following calculation formula:
$$M = \frac{{f}_{1}}{{f}_{1} - t}$$
wherein, f₁ is a focal length of the first diffractive optical element lens array, t is an effective distance between the first diffractive optical element lens array and the second diffractive optical element lens array, and a value of the effective distance is equal to a geometrical distance between the first diffractive optical element lens array and the second diffractive optical element lens array divided by a refractive index of a medium.

11. The mixed reality display device according to claim 1, wherein there is an air layer between the second diffractive optical element lens array and the waveguide element.

12. The mixed reality display device according to claim 1, further comprising:
a mask element located between the second diffractive optical element lens array and the waveguide element, and configured to eliminate a phenomenon of crosstalk between the diffractive optical element lenses.

13. The mixed reality display device according to claim 12, wherein the mask element is produced by scoring a surface of a transparent element and filling with a light absorbing material.

14. The mixed reality display device according to claim 1, wherein the first diffractive optical element lens array is a holographic optical element.

15. The mixed reality display device according to claim 1, wherein the second diffractive optical element lens array is a holographic optical element.
